(19) United States
(12) Patent Application Publication
(10) Pub. No.: US 2024/0078824 A1
(43) Pub. Date: Mar. 7, 2024

(54) SYSTEM OF DETECTING CHEATING ON AN ONLINE EXAMINATION

(71) Applicant: LuGo Test Technologies Ltd., Tel Aviv (IL)

(72) Inventors: Mor ALMADO, Kfar Saba (IL); Uri LUKACH, Tel Aviv (IL)

(21) Appl. No.: 18/210,563

(22) Filed: Jun. 15, 2023

(30) Foreign Application Priority Data
Sep. 4, 2022 (IL) 296181

(51) Int. Cl. G06V 30/19; G06V 30/14

(52) U.S. Cl. CPC G06V 30/1908; G06V 30/1452; G06V 30/1456; G09B 7/00

(57) ABSTRACT

There is provided a computer system of detecting user cheating in an online test, the system comprising a processing circuitry configured to: obtain capability of performing screen capture of a user computer; perform a screen capture of the user computer; perform at least one of: i) extracting one or more text strings from one or more non-examination application windows of the userscreen image, obtaining at least part of an examination question text that has been presented in an application window on the user computer, and for at least one of the one or more extracted text strings, determining a degree of relevance to the examination question text, and ii) determining, using image analysis techniques, a degree of matching between at least part of the at least one userscreen image, and data associated with a suspicious application.

### TECHNICAL FIELD

The presently disclosed subject matter relates to systems of automated administration of examinations, and in particular to detecting cheating on such systems.

### Background

Problems of detecting cheating on online tests has been recognized in the conventional art and various techniques have been developed to provide solutions.

### General Description

According to one aspect of the presently disclosed subject matter there is provided a computer system of detecting user cheating in an online test, the system comprising a processing circuitry, the processing circuitry comprising a processor and memory, the processing circuitry being configured to:
a) obtain capability of performing screen capture of a user computer;
b) obtain at least part of an examination question text that has been presented in an application window on the user computer;
c) perform a screen capture of the user computer, thereby giving rise to a userscreen image;
d) extract, using image analysis techniques, from, at least, one or more non-examination application windows of the userscreen image, at least one of:
   i. one or more text strings, and
   ii. one or more images;
e) perform at least one of:
   i. for at least one of the one or more extracted text strings, determining a degree of relevance to the examination question text, thereby facilitating assessment of a likelihood of cheating, based on the determined degrees of relevance; and
   ii. for at least one of the one or more extracted images. using image analysis techniques to determine a degree of matching with each image in a given list of suspicious images,
      thereby facilitating assessment of a likelihood of cheating, based on the determined degrees of matching.

In addition to the above features, the system according to this aspect of the presently disclosed subject matter can comprise one or more of features (i) to (xi) listed below, in any desired combination or permutation which is technically possible:
the performing screen capture of the user computer is configured to be responsive to detecting a focus of the user computer being a non-examination application or subapplication.
(ii) the extracting is from the entire userscreen image
(iii) the processing circuitry is further configured to, prior to step d):
   identify a current in-focus application window;
   and the one or more non-examination application windows comprises the identified current in-focus application window.
(iv) the extracting comprises:
   a) identifying, utilizing image analysis techniques, in the userscreen image, an application window; and
   b) responsive to determining that the identified application window is a non-examination application window, extracting one or more text strings from the identified application window.
(v) the extracting one or more text strings from the identified application window is responsive to determining that the identified application window is not a non-suspicious application window.
(vi) the determining that the identified application window is a non-examination application window comprises:
   comparing an application window identification string with an examination window title.
(vii) the processing circuitry is further configured to:
   iii. periodically repeat c)-e).
(viii) the performing screen capture of the user computer is configured to capture more than one user screen, and to thereby give rise to more than one non-examination activity userscreen image, and wherein the processing circuitry is configured to perform d)-e) on each of the more than one non-examination activity userscreen image.
(ix) the determining the degree of relevance comprises:
   determining a longest common substring between at least part of at least one of the one or more text strings and the at least part of the examination question text.
(x) the determining the degree of relevance further comprises:
   comparing the longest common substring result to a substring matching threshold,
   thereby giving rise to a boolean assessment of suspicion of user cheating.
(xi) the determining the degree of relevance comprises:
   determining a longest common sub string between at least part of at least one of the one or more text strings and the at least part of the examination question text.

According to another aspect of the presently disclosed subject matter there is provided a computer-implemented method of detecting user cheating in an online test, the method comprising:
a) obtaining capability of performing screen capture of a user computer;
b) obtaining at least part of an examination question text that has been presented in an application window on the user computer;
c) performing a screen capture of the user computer, thereby giving rise to a userscreen image;
d) extracting, using image analysis techniques, from, at least, one or more non-examination application windows of the userscreen image, at least one of:
   i. one or more text strings, and
   ii. one or more images;
e) performing at least one of:
   i. for at least one of the one or more extracted text strings, determining a degree of relevance to the examination question text, thereby facilitating assessment of a likelihood of cheating, based on the determined degrees of relevance; and
   ii. for at least one of the one or more extracted images. using image analysis techniques to determine a degree of matching with each image in a given list of suspicious images,
      thereby facilitating assessment of a likelihood of cheating, based on the determined degrees of matching.

This aspect of the disclosed subject matter can further optionally comprise one or more of features (i) to (xi) listed above with respect to the system, mutatis mutandis, in any desired combination or permutation which is technically possible.

According to another aspect of the presently disclosed subject matter there is provided a computer program product comprising a computer readable non-transitory storage medium containing program instructions, which program instructions when read by a processor, cause the processing circuitry to perform a method of detecting user cheating in an online test, the method comprising:
a) obtaining capability of performing screen capture of a user computer;
b) obtaining at least part of an examination question text that has been presented in an application window on the user computer;
c) performing a screen capture of the user computer, thereby giving rise to a userscreen image;
d) extracting, using image analysis techniques, from, at least, one or more non-examination application windows of the userscreen image, at least one of:
   i. one or more text strings, and
   ii. one or more images;
e) performing at least one of:
   i. for at least one of the one or more extracted text strings, determining a degree of relevance to the examination question text,
      thereby facilitating assessment of a likelihood of cheating, based on the determined degrees of relevance; and
   ii. for at least one of the one or more extracted images. using image analysis techniques to determine a degree of matching with each image in a given list of suspicious images,
      thereby facilitating assessment of a likelihood of cheating, based on the determined degrees of matching.

This aspect of the disclosed subject matter can further optionally comprise one or more of features (i) to (xi) listed above with respect to the system, mutatis mutandis, in any desired combination or permutation which is technically possible.

According to one aspect of the presently disclosed subject matter there is provided a computer system of detecting user cheating in an online test, the system comprising a processing circuitry, the processing circuitry comprising a processor and memory, the processing circuitry being configured to:
a) obtain capability of performing screen capture of a user computer;
b) perform a screen capture of the user computer, thereby giving rise to at least one userscreen image;
c) perform, at least, at least one of:
   i. extracting, using image analysis techniques, one or more text strings from, at least, one or more non-examination application windows of the at least one userscreen image,
      obtaining at least part of an examination question text that has been presented in an application window on the user computer, and for at least one of the one or more extracted text strings, determining a degree of relevance to the examination question text, thereby facilitating assessment of a likelihood of cheating, based on the determined degree of relevance, and
   ii. determining, using image analysis techniques, a degree of matching between at least part of the at least one userscreen image, and data associated with a suspicious application, thereby facilitating assessment of a likelihood of cheating, based on the determined degree of matching.

In addition to the above features, the system according to this aspect of the presently disclosed subject matter can comprise one or more of features (i) to (xi) listed below, in any desired combination or permutation which is technically possible:
i. the processing circuitry is configured to perform determining the degree of matching between an image of a browsed uniform resource locator (URL) comprised in the at least one userscreen image, and a given suspicious URL
ii. the processing circuitry is configured to perform determining the degree of matching between an at least partial image of a browsed website comprised in the at least one userscreen image, and a given at least partial image of a suspicious web site
iii. the processing circuitry is configured to perform determining the degree of matching between an at least partial image of a browsed website comprised in the at least one userscreen image, and one or more given text strings of a suspicious web site.
iv. the determining the degree of relevance comprises:
   determining a longest common substring between at least part of at least one of the one or more text strings and the at least part of the examination question text.
v. the determining the degree of relevance further comprises:
   comparing the longest common substring result to a substring matching threshold,
   thereby giving rise to a boolean assessment of suspicion of user cheating.
vi. the processing circuitry is configured to perform screen capture of the user computer responsive to detecting a focus of the user computer being a non-examination application or subapplication.
vii. the processing circuitry is further configured to:
   a) periodically repeat b)-c) one or more additional times.
viii. the processing circuitry is further configured to, prior to step c):
   identify a current in-focus application window in the at least one userscreen image; and
   reduce the at least one userscreen image to a reduced at least one userscreen image that comprises the identified current in-focus application window.
ix. the processing circuitry is configured to perform the extracting by, at least:
   i. identifying, utilizing image analysis techniques, in the at least one userscreen image, an application window; and
   ii. responsive to determining that the identified application window is a non-examination application window, extracting one or more text strings from the identified application window.
x. the extracting one or more text strings from the identified application window is responsive to determining that the identified application window is a non-examination application window.
xi. determining that the identified application window is a non-examination application window comprises:
   comparing an application window identification string with an examination window title.

According to another aspect of the presently disclosed subject matter there is provided a computer-implemented method of detecting user cheating in an online test, the method comprising:
a) obtaining capability of performing screen capture of a user computer;
b) performing a screen capture of the user computer, thereby giving rise to at least one userscreen image;
c) performing, at least, at least one of:
   i. extracting, using image analysis techniques, one or more text strings from, at least, one or more non-examination application windows of the at least one userscreen image,
      obtaining at least part of an examination question text that has been presented in an application window on the user computer, and for at least one of the one or more extracted text strings, determining a degree of relevance to the examination question text, thereby facilitating assessment of a likelihood of cheating, based on the determined degree of relevance, and
   ii. determining, using image analysis techniques, a degree of matching between at least part of the at least one userscreen image, and data associated with a suspicious application, thereby facilitating assessment of a likelihood of cheating, based on the determined degree of matching.

This aspect of the disclosed subject matter can further optionally comprise one or more of features (i) to (xi) listed above with respect to the system, mutatis mutandis, in any desired combination or permutation which is technically possible.

According to another aspect of the presently disclosed subject matter there is provided a computer program product comprising a computer readable non-transitory storage medium containing program instructions, the program instructions when read by a processing circuitry, causing the processing circuitry to perform a method of detecting user cheating in an online test, the method comprising:
d) obtaining capability of performing screen capture of a user computer;
e) performing a screen capture of the user computer, thereby giving rise to at least one userscreen image;
f) performing, at least, at least one of:
   i. extracting, using image analysis techniques, one or more text strings from, at least, one or more non-examination application windows of the at least one userscreen image,
      obtaining at least part of an examination question text that has been presented in an application window on the user computer, and for at least one of the one or more extracted text strings, determining a degree of relevance to the examination question text, thereby facilitating assessment of a likelihood of cheating, based on the determined degree of relevance, and
   ii. determining, using image analysis techniques, a degree of matching between at least part of the at least one userscreen image, and data associated with a suspicious application, thereby facilitating assessment of a likelihood of cheating, based on the determined degree of matching.

This aspect of the disclosed subject matter can further optionally comprise one or more of features (i) to (xi) listed above with respect to the system, mutatis mutandis, in any desired combination or permutation which is technically possible.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates an example deployment of an online examination system with its components, according to some embodiments of the presently disclosed subject matter;

FIG. 2A illustrates an example digital snapshot of a user display, according to some embodiments of the presently disclosed subject matter;

FIG. 2B illustrates an additional example digital snapshot of a user display, according to some embodiments of the presently disclosed subject matter;

FIG. 3A illustrates a flow diagram of an example method of detecting examinee cheating in an online test, according to some embodiments of the presently disclosed subject matter;

FIG. 3B illustrates a flow diagram of another example method of detecting examinee cheating in an online test, according to some embodiments of the presently disclosed subject matter;

FIG. 4A illustrates an example method of extracting text strings and or images, from a userscreen image, utilizing application window focus, according to some embodiments of the presently disclosed subject matter; and

FIG. 4B illustrates an example method of extracting text strings and or images, from a userscreen image, utilizing application window type identification, according to some embodiments of the presently disclosed subject matter;

FIG. 5A illustrates a flow diagram of an example scenario of a system detecting cheating by an examinee, according to some embodiments of the presently disclosed subject matter; and

FIG. 5B illustrates a flow diagram of another example scenario of a system detecting cheating by an examinee, according to some embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “comparing”, “notifying”, “inspecting”, “determining”, “calculating” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the control unit therein disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

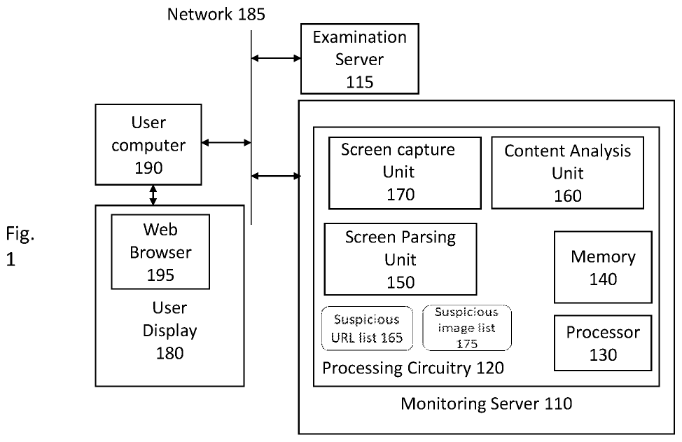

Attention is now directed to FIG. 1, which illustrates an example deployment of an online examination system with its components, in accordance with some embodiments of the presently disclosed subject matter.

User computer 190 can be a computer (e.g. personal computer, mobile device, tablet, etc.) that a person is using to take an online test. User display 180 (which can be operably connected to user computer 190) can be the display of user computer 190. It is noted that user computer 190 can support multiple monitors i.e. support multiple instances of user display 180.

User computer 190 can execute, for example, an operating system (e.g. Microsoft Windows, Apple MacOS, Linux, Android etc) which displays individual application activity on user display 180 in individual application windows. Such applications can include, for example, web browser 195.

Web browser 195 can display one or more browsing tabs. In some embodiments, a user can perform an online skills test in a tab of web browser 195. In some other embodiments, a user can perform an online skills test in a different application on user display 180.

Network 185 can be a group of network links providing wired and/or wireless connectivity between user computer 190 and examination server 115 and monitoring server 110. For example, network 185 can be the internet, or a local area network.

Examination Server 115 can be a server which provides online testing (e.g. professional skills testing such as programming, academic testing such as math or history etc.) to user computer 190. In some embodiments, examination server 115 can present questions or “problems” to the user, to which the user is required to provide an answer or solution. Such questions or problems are herein termed “examination questions”. In some embodiments, during a time period when the user is required to solve the examination question and provide a response, the examination question is herein termed a “pending examination question”.

Monitoring server 110 can be a server that is operably connected to network 185 and inspects behavior of the user on user display 180 to evaluate the likelihood of a user cheating during the online skills test (for example, a user might copy code from a programmer's forum to provide a response to a pending examination question of a programming test). Methods utilized by monitoring server 110 are described in detail below.

In some embodiments, examination server 115 and monitoring server 110 are collocated in a single server.

Monitoring server 110 can include processing circuitry 120. Processing circuitry 120 can include processor 130 and memory 140.

Processor 130 can be a suitable hardware-based electronic device with data processing capabilities, such as, for example, a general purpose processor, digital signal processor (DSP), a specialized Application Specific Integrated Circuit (ASIC), one or more cores in a multicore processor, etc. Processor 130 can also consist, for example, of multiple processors, multiple ASICs, virtual processors, combinations thereof etc.

Memory 140 can be, for example, a suitable kind of volatile and/or non-volatile storage, and can include, for example, a single physical memory component or a plurality of physical memory components. Memory 140 can also include virtual memory. Memory 140 can be configured to, for example, store various data used in computation.

Processing circuitry 120 can be configured to execute several functional modules in accordance with computer-readable instructions implemented on a non-transitory computer-readable storage medium. Such functional modules are referred to hereinafter as comprised in the processing circuitry. These modules can include, for example, screen capture unit 170, screen parsing unit 150, content analysis unit 160.

Screen capture unit 170 can utilize screen capture technologies (such as those that exist in modern web browsers, as will be described hereinbelow) to acquire digital image snapshots of user display 180.

Screen parsing unit 150 can utilize, for example, image processing techniques to isolate and/or extract different elements of the captured digital image snapshots, and extract text and/or images that are of interest in detecting potential examination cheating.

Content analysis unit 160 can assess text and/or images (e.g. as extracted from digital image snapshots of user display 180) for indications of potential examination cheating.

It is noted that the teachings of the presently disclosed subject matter are not bound by the monitoring server, examination server, and user computer described with reference to FIG. 1. Equivalent and/or modified functionality can be consolidated or divided in another manner and can be implemented in any appropriate combination of software with firmware and/or hardware and executed on a suitable device. The monitoring server, examination server, and user computer can be standalone network entities, or integrated, fully or partly, with other entities.

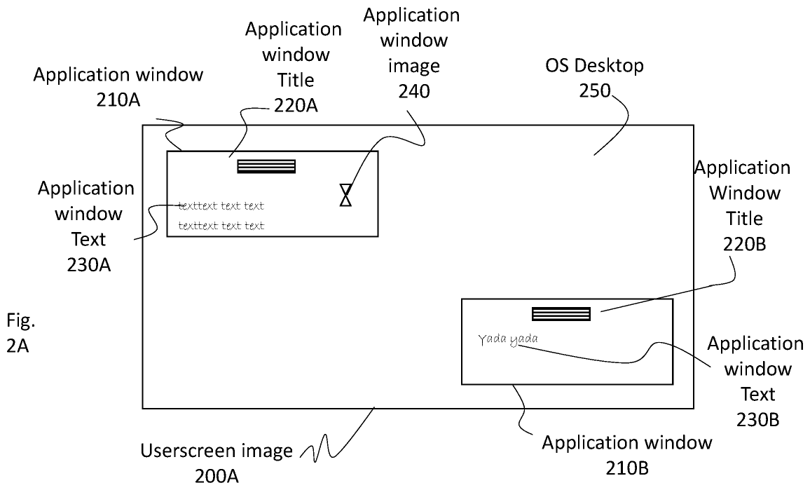

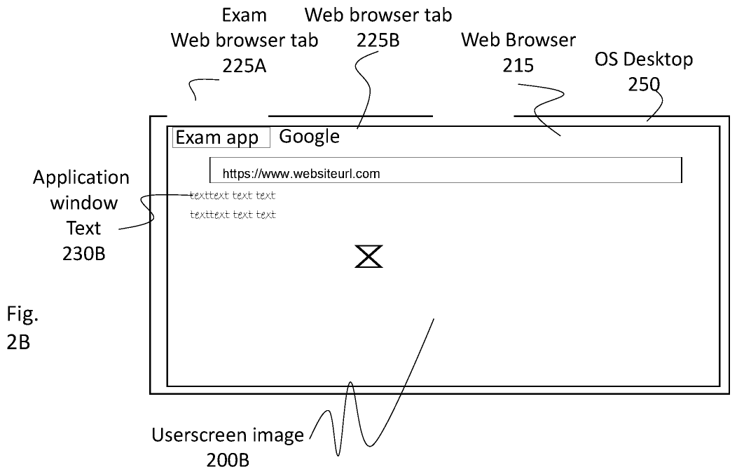

Attention is directed to FIG. 2A, which illustrates an example digital snapshot of a user display 180, in accordance with some embodiments of the presently disclosed subject matter.

Userscreen image 200A can be a digital image resulting from snapshotting (e.g. by monitoring server 110) a user display 180 (for example: in response to a change in user interface focus from one application window to another, as will be described hereinbelow).

Userscreen image 200A can include zero or more application windows 210A 210B. An application window can be a graphical element providing a user with input and/or output associated with an application on user computer 190. application windows 210A 210B can be rectangular or another shape.

In some embodiments, application windows 210A 210B include an application window title 220A 220B (for example, on a toolbar at the top of the application window 210A 210B). an application window title 220A 220B can name or otherwise describe the application associated with the application window. By way of non-limiting example: the title can be a name of the application (e.g. “Notepad”). By way of further non-limiting example, the title can be a name of the application in combination with a name of a file being edited by the application (e.g. “Notepad—foo.txt). By way of further non-limiting example, the title can be a title of a website being viewed in a web browser (or in a tab of the web browser).

Application windows 210A 210B can display application window text 230A 230B. If Application windows 210A 210B is associated with—for example—a web browser, then application window text 230A 230B can include a uniform resource locator (URL) from the browser (or browser tab) and/or text displayed by the website being viewed.

Application windows 210A 210B can display an application window image 240. If Application windows 210A 210B is associated with a web browser, then application window image 240 can be an image displayed by the website being viewed.

In some examples, an application window 210A 210B is a web browser 195 viewing a website of examination server 115. More specifically: the user of user computer 190 can be taking an online test (administered by examination server 115) over web browser 195 on user display 180.

OS Desktop 250 can be the background of userscreen image 200A. OS Desktop 250 can be blank or include a “wallpaper” image. OS Desktop 250 can also include application icons, search toolbar etc. (not shown).

Attention is directed to FIG. 2B, which illustrates a further example digital snapshot of a user display 180, in accordance with some embodiments of the presently disclosed subject matter.

In this case, web browser 215 maintains two open tabs (“exam app” web browser tab 225A, and “Google” web browser tab 225B). A cheating examinee might copy text from a question from “exam app” web browser tab 225A to “Google” web browser tab 225B (which would then appear as application window text 230B).

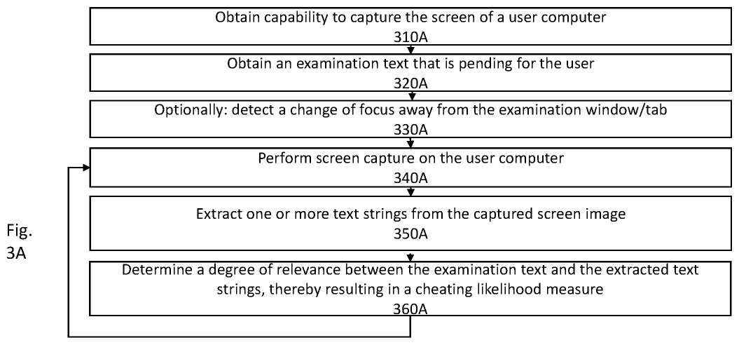

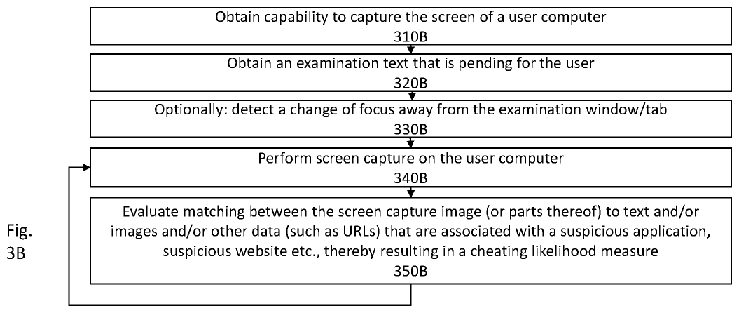

Attention is now directed to FIG. 3A, which illustrates a flow diagram of an example method of detecting examinee cheating in an online test, in accordance with some embodiments of the presently disclosed subject matter.

Processing circuitry 120 (for example: screen capture unit 130) can obtain (310A) capability to capture the screen (or screens) of the computer of the examinee e.g., user display 180 of user computer 190. In some embodiments, processing circuitry 120 (for example: screen capture unit 130) interacts with the user computer 190 via a web browser 195 that utilizes hypertext transfer protocol (HTTP). In this case, processing circuitry 120 (for example: screen capture unit 130) can, for example, utilize the getDisplayMedia function of the screen capture application programmer's interface (API) that is supported by many modern web browsers such as Chrome, Firefox etc.(cf. https://vww.w3.org/TR/screen-capture/).

In some other embodiments, a different suitable mechanism can be used to acquire screen capture capability.

It is noted that, in some examples, contemporary browsers facilitate providing capture of the entire computer screen (or screens) via the screen capture API, and not merely the browser or browser tabs.

In some embodiments, processing circuitry 120 (for example: screen capture unit 130) additionally obtains (e.g. via the screen capture API) capability to detect when there is change of focus (on e.g., user display 180 of user computer 190) from one application window to another application window (e.g. due to a mouse click operation by the examinee). In some examples, processing circuitry 120 (for example: screen capture unit 130) can also detect a change in focus within an application (for example: from one web browser tab to another).

Processing circuitry 120 (for example: content analysis unit 140) can receive (320A) all or part of an examination text that is pending for the user. For example: the examination text can be an examination question that has been displayed to the examinee in a window of a web browser, and which the examinee is currently required to answer. In some embodiments, monitoring server 110 can be collocated with examination server 115, so that the currently pending examination text will be automatically available. In some embodiments, monitoring server 110 can receive data indicative of a pending examination text from examination server 115 e.g. via network 185.

Processing circuitry 120 (for example: screen capture unit 130) can next perform (340A) screen capture of the screen(s) of user computer 190. If there is more than one screen, processing circuitry 120 (for example: screen capture unit 130) can capture all of them. Alternatively, processing circuitry 120 (for example: screen capture unit 130) can restrict user computer 190 (e.g. via Screen Capture API) so that only one screen of user computer 190 is usable by the examinee. Alternatively, processing circuitry 120 (for example: screen capture unit 130) can capture only the screen of user computer 190 which includes the application window that is currently in-focus. Alternatively, processing circuitry 120 (for example: screen capture unit 130) can capture only the application window (e.g. web browser) that is currently in-focus.

By way of non-limiting example, processing circuitry 120 (for example: screen capture unit 130) can utilize the Screen Capture API (described above) to capture the screen(s).

An image resulting from the screen capture performed by processing circuitry 120 (for example: screen capture unit 130) is herein termed a userscreen image. In some embodiments, the userscreen image is subsequently analyzed to assess likelihood of examinee cheating.

In some embodiments, processing circuitry 120 (for example: screen capture unit 130) can maintain data indicative of which application is currently active on user display 180. For example, processing circuitry 120 (for example: screen capture unit 130) can maintain data on which application or which browser tab is currently “in focus” (for example: which window or browser tab is the location where the examinee is currently entering text).

In some such embodiments, processing circuitry 120 (for example: screen capture unit 130) can detect (330A) a change of focus away from e.g. the browser tab of the examination to a different non-examination application, or to a different non-examination “subapplication” within the same application (e.g. a browser tab). The change in focus can result, for example, from a mouse-click by the examinee). Processing circuitry 120 (for example: screen capture unit 130) can then perform (340) screen capture responsive to the detected change of focus. In this manner, processing circuitry 120 (for example: screen capture unit 130) can restrict the performing of the screen capture to when the examinee is possibly engaged in cheating or other non-examination activity in another application or subapplication.

In some embodiments, processing circuitry 120 (for example: screen capture unit 130) performs screen capture without prior detection of a change of focus (e.g. periodically).

Processing circuitry 120 (for example: screen parsing unit 150) can next utilize (350) e.g. image processing techniques to extract text from the userscreen image for further analysis.

By way of non-limiting example: processing circuitry 120 (for example: screen parsing unit 150) can extract all text from the userscreen image (e.g. the entire userscreen image). In this case, text from the operating system's “desktop” interface may be extracted in addition to the text from the application windows.

In some embodiments, processing circuitry 120 (for example: screen parsing unit 150) can remove the examination application window from the userscreen image before performing text/image extraction (for example: by utilizing screenAPI info pertaining to the screen location of the examination application window).

In some embodiments, processing circuitry 120 (for example: screen parsing unit 150) can determine that the examination application window is not visible (e.g. the window might be minimized, or hidden behind another browser tab), and extract text only in this circumstance, thereby avoiding false-positive alerts resulting from extraction of text from the examination window. In some other embodiments, processing circuitry 120 (for example: screen parsing unit 150) does not perform such processing for avoiding false-positive alerts.

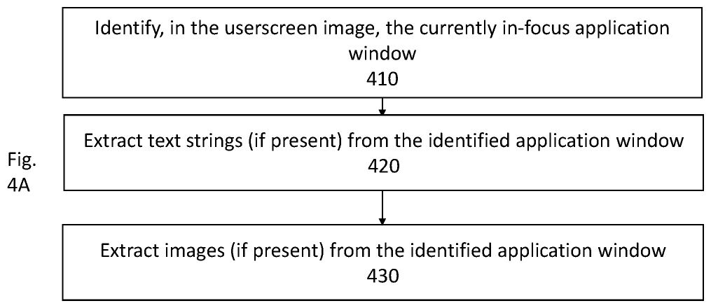

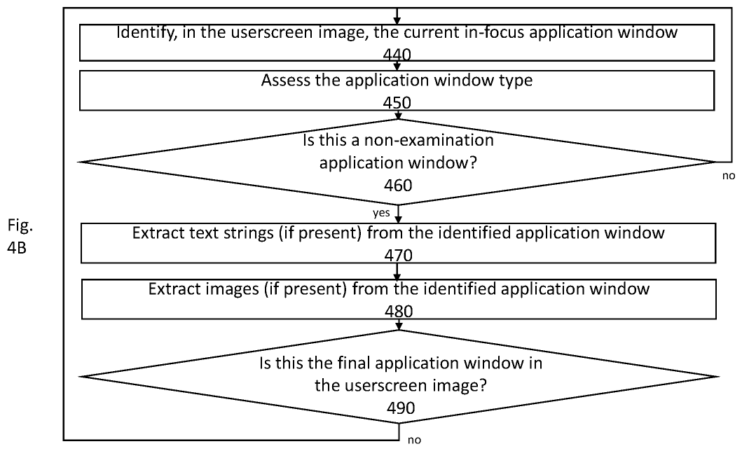

Additional example methods for using image processing techniques to extract text for further analysis is described below, with reference to FIGS. 4A-4B.

It is noted that the method described in FIG. 4A identifies the currently in-focus application window, and can extract text and/or images from it.

It is noted that the method described in FIG. 4B identifies each application window, and can extract text and/or images from application windows that are assessed as being non-examination application windows.

It is further noted that in some other embodiments, other methods of extracting text and/or images from a userscreen image can be utilized.

If the analysis/parsing of the userscreen image conducted by processing circuitry 120 (for example: screen parsing unit 150) results in at least one text string, processing circuitry 120 (for example: screen parsing unit 150) can proceed to evaluate the text string(s) to determine a likelihood of examinee cheating.

To determine a likelihood of examinee cheating, processing circuitry 120 (for example: content analysis unit 140) can determine (360) a degree of relevance of the extracted text strings to the obtained examination question text or a portion thereof. If the extracted text strings are highly relevant to the examination question text, this can be an indication that the examinee attempted to utilize e.g. online resources such as webforums to answer the question.

In some embodiments, processing circuitry 120 (for example: content analysis unit 140) determines a degree of relevance by determining a longest common substring between each text string of the extracted text strings and at least part of the obtained examination question text. Example algorithms for computing a longest common substring are described for example at https://en.wikipedia.org/Longest_common_substring_problem.

The resulting length of the longest matching substring can then indicate a degree of relevance. In some embodiments, processing circuitry 120 (for example: content analysis unit 140) compares the length of the longest common substring to a length threshold, resulting in a Boolean assessment of whether examinee cheating is likely.

It is noted that the determination of longest common substring can be performed in various ways, including methods that modify or delete whitespace from both texts and calculate the longest common substring value accordingly.

In some embodiments, before performing the substring matching, processing circuitry 120 (for example: content analysis unit 140) creates the single derivative text string by concatenating the extracted text strings together.

In some other embodiments, processing circuitry 120 (for example: content analysis unit 140) determines a likelihood of examinee cheating by employing machine learning or another method to assess similarity between the extracted text strings and part or all of the pending examination text.

Processing circuitry 120 (for example: screen capture unit 140) can next perform (340) another screen capture (for example: after an expiration of a timer). In some embodiments, processing circuitry 120 (for example: screen capture unit 140) can detect return of operating system focus to the examination application window. In some such embodiments, monitoring server 110 can halt performing screen captures until the examinee once again changes (330) operating system focus away to a different application window.

It is noted that the teachings of the presently disclosed subject matter are not bound by the flow chart illustrated in FIG. 3A, the illustrated operations can occur out of the illustrated order. For example, operations 310A and 320A, shown in succession, can be executed substantially concurrently, or in the reverse order. It is also noted that whilst the flow chart is described with reference to elements of the system of FIG. 1 or screen images of FIGS. 2A-2B, this is by no means binding, and the operations can be performed by elements other than those described herein.

Attention is directed to FIG. 3B, which illustrates a flow diagram of another example method of detecting examinee cheating in an online test, according to some embodiments of the presently disclosed subject matter;

In this version of the method, after performing screen capture, processing circuitry 120 (for example: content analysis unit 160) can determine (350) a degree of matching between the captured userscreen image (or parts thereof) to text and/or images and/or other data that are associated with a suspicious application, suspicious website etc., thereby resulting in a cheating likelihood measure.

By way of non-limiting example: processing circuitry 120 (for example: content analysis unit 160) can extract text from e.g. a window of a browser in a non-examination application window of the userscreen image. In some such embodiments, processing circuitry 120 (for example: content analysis unit 160) then determines a degree of matching between the extracted text and given text that appears on a suspicious website (such as a banner text or disclaimer text of an interactive large language model like ChatGPT, programmer forum etc.) or on another application that can access suspicious content.

In some other embodiments, processing circuitry 120 (for example: content analysis unit 160) can determine a degree of matching between text in the userscreen image and text of a suspicious website or other application without actually extracting the text (for example by comparing pixels, performing machine learning classification etc.)

In some embodiments, processing circuitry 120 (for example: content analysis unit 160) evaluates the degree of matching for all text appearing in the userscreen image. In some embodiments, processing circuitry 120 (for example: content analysis unit 160) evaluates matching for some subset of the text appearing in the userscreen image.

By way of further non-limiting example: processing circuitry 120 (for example: content analysis unit 160) can extract text of a uniform resource locator (URL) that is in e.g. a toolbar of a browser (or other application) in a non-examination application window in the at least one userscreen image. In some such embodiments, processing circuitry 120 (for example: content analysis unit 160) then determines a degree of matching between the extracted URL and a URL from a given list of suspicious URLs.

In some other embodiments, processing circuitry 120 (for example: content analysis unit 160) determines a degree of matching between a URL in the userscreen image and a URL from a given list of suspicious URLs without first doing text extraction (for example by comparing pixels, performing machine learning classification etc.)

In some embodiments, processing circuitry 120 (for example: content analysis unit 160) can evaluate the degree of matching for all URLs appearing in the userscreen image, of for some subset of these.

By way of further non-limiting example: processing circuitry 120 (for example: content analysis unit 160) can extract images e.g. from a window of a browser in a non-examination application window of the at least one userscreen image. In some such embodiments, processing circuitry 120 (for example: content analysis unit 160) then determines a degree of matching between extracted image(s) and an image appearing on suspicious website (such as a logo appearing on a website of an interactive large language model like ChatGPT, programmer forum etc.) or on other application that can access suspicious content. In some embodiments, processing circuitry 120 (for example: content analysis unit 160) determines a degree of matching between an image of a website in a browser and a given image of a suspicious website.

In some embodiments, processing circuitry 120 (for example: content analysis unit 160) can evaluate the degree of matching for multiple images appearing in the userscreen image. In some embodiments, processing circuitry 120 (for example: content analysis unit 160) can evaluate the degree of matching for a single image contained in the userscreen image.

To evaluate matching, processing circuitry 120 (for example: content analysis unit 140) can utilize machine learning-based or other algorithms to provide a degree or metric of similarity between two images.

In some embodiments, processing circuitry 120 (for example: content analysis unit 140) can evaluate matching between one or more extracted application window title text strings and a given list or database of suspicious window titles.

In some embodiments, processing circuitry 120 (for example: content analysis unit 140) evaluates combinations of characteristics described above, For example: matching extracted text strings and/or extracted images to a group of suspicious text strings and/or a group of suspicious images (e.g. maintained in a database). For example: processing circuitry 120 (for example: content analysis unit 140) can use two specific logo images in combination with a web page footer text to identify a website used for cheating. In some embodiments, processing circuitry 120 (for example: content analysis unit 140) can additionally utilize data (e.g. from a database) about absolute or relative placement of such text and/or images within a webpage. For example: processing circuitry 120 (for example: content analysis unit 140) can use two specific logo images at particular positions on the webpage in combination with a web page footer text to identify a website used for cheating.

It is noted that the teachings of the presently disclosed subject matter are not bound by the flow chart illustrated in FIG. 3B, the illustrated operations can occur out of the illustrated order. For example, operations 310B and 320B, shown in succession, can be executed substantially concurrently, or in the reverse order. It is also noted that whilst the flow chart is described with reference to elements of the system of FIG. 1 or screen images of FIGS. 2A-2B, this is by no means binding, and the operations can be performed by elements other than those described herein.

Attention is now directed to FIG. 4A, which illustrates an example method of extracting text strings and/or images—from a userscreen image—for assessment of a likelihood of online cheating, in accordance with some embodiments of the presently disclosed subject matter.

Processing circuitry 220 (for example: screen parsing unit 250) can identify, in the userscreen image, the currently in-focus application window. Processing circuitry 220 (for example: screen parsing unit 250) can perform this identification, for example, by utilizing information provided by the Screen Capture API described above. Alternatively, processing circuitry 220 (for example: screen parsing unit 250) can perform the identification by detecting application window characteristics (such as colors or fonts) that are indicative of focus on a particular operating system. Alternatively, processing circuitry 220 (for example: screen parsing unit 250) can perform the identification by identifying a location of an input cursor, or by another suitable method.

Processing circuitry 220 (for example: screen parsing unit 250) can then extract (420) all or part of the text from the identified application window (i.e. if text is present), thereby resulting in one or more text strings.

In some embodiments, processing circuitry 220 (for example: screen parsing unit 250) employs optical character recognition (OCR) to identify and extract text in the application window (or from one or more specific portions thereof).

In some embodiments, a distinct block of text in the application window (e.g. a sentence, a paragraph, or a grouping of paragraphs such as search engine results) can be extracted to an individual text string, so that the text in the application window results in multiple text strings. In some embodiments, all the text in the application window is extracted to a single text string.

In some embodiments, processing circuitry 220 (for example: screen parsing unit 250) can associate text strings with data indicative of an application name (e.g. as indicated by an application window title string of an identified application window or other techniques as described above). By way of non-limiting example: processing circuitry 220 (for example: screen parsing unit 250) can associate a particular URL text string with a web browser (or browser tab) from which it was extracted.

In some embodiments, processing circuitry 220 (for example: screen parsing unit 250) employs image processing techniques to extract (430) images from the identified application window, thereby resulting in one or more images extracted from the non-examination application window.

It is noted that the teachings of the presently disclosed subject matter are not bound by the flow chart illustrated in FIG. 4A, the illustrated operations can occur out of the illustrated order. For example, operations 420 and 430, shown in succession, can be executed substantially concurrently, or in the reverse order. It is also noted that whilst the flow chart is described with reference to elements of the system of FIG. 1 or screen images of FIGS. 2A-2B, this is by no means binding, and the operations can be performed by elements other than those described herein.

Attention is now directed to FIG. 4B, which illustrates an example method of extracting text strings and/or images—from a userscreen image—for assessment of a likelihood of online cheating, in accordance with some embodiments of the presently disclosed subject matter.

Processing circuitry 220 (for example: screen parsing unit 250) can employ image processing techniques to identify (440) an application window in the userscreen image. In some embodiments, processing circuitry 220 (for example: screen parsing unit 250) can utilize operating-system-specific awareness of application window characteristics to perform this identification.

Processing circuitry 220 (for example: screen parsing unit 250) can next assess (450) whether the identified application window is the examination application window or a non-examination application window (i.e. determination of an “application window type”)|. In some embodiments, processing circuitry 220 (for example: screen parsing unit 250) utilizes a text of an application window title 220A 220B to make this assessment. By way of non-limiting example: processing circuitry 220 (for example: screen parsing unit 250) can examine a website name appearing in an application window title (or URL appearing in a browser or browser tab toolbar), and assess whether the title (or URL) is indicative of a web browser accessing examination server 115. Alternatively: processing circuitry 220 (for example: screen parsing unit 250) can examine other suitable characteristics—such as layout of the contents of the identified application window, operating system process status information, or other features of the application (e.g. distinctive colors of a calculator application) etc.

If the application window is assessed as a non-examination application window (460), processing circuitry 220 (for example: screen parsing unit 250) can then extract (470) all or part of the text from the identified application window (i.e. if text is present), thereby resulting in one or more text strings.

In some embodiments, processing circuitry 220 (for example: screen parsing unit 250) employs optical character recognition (OCR) to identify and extract text in the application window.

In some embodiments, a distinct block of text in the application window (e.g. a sentence, a paragraph, or a grouping of paragraphs such as search engine results) can be extracted to an individual text string, so that the text in the application window results in multiple text strings. In some embodiments, all the text in the application window is extracted to a single text string.

In some embodiments, processing circuitry 220 (for example: screen parsing unit 250) can associate text strings with data indicative of an application name (e.g. as indicated by an application window title string of an identified application window or other techniques as described above).

In some embodiments, processing circuitry 220 (for example: screen parsing unit 250) employs image processing techniques to extract (480) images from the identified application window, thereby resulting in one or more images extracted from the non-examination application window.

In some embodiments, processing circuitry 220 (for example: screen parsing unit 250) can associate images with data indicative of an application name (e.g. as indicated by an application window title string of an identified application window or other techniques as described above).

If the current application window is not the final (490) application window in the userscreen image, processing circuitry 220 (for example: screen parsing unit 250) can return to identify (440) the next application window.

It is noted that the teachings of the presently disclosed subject matter are not bound by the flow chart illustrated in FIG. 4B, the illustrated operations can occur out of the illustrated order. For example, operations 470 and 480, shown in succession, can be executed substantially concurrently, or in the reverse order. It is also noted that whilst the flow chart is described with reference to elements of the system of FIG. 1 or screen images of FIGS. 2A-2B, this is by no means binding, and the operations can be performed by elements other than those described herein.

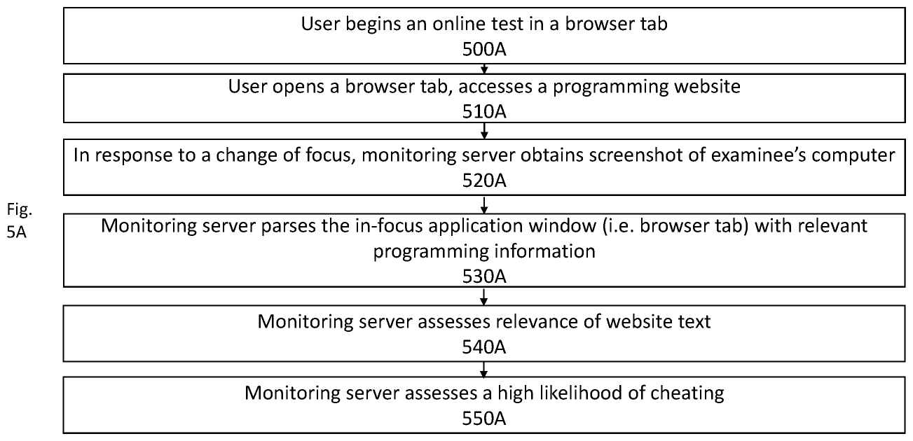

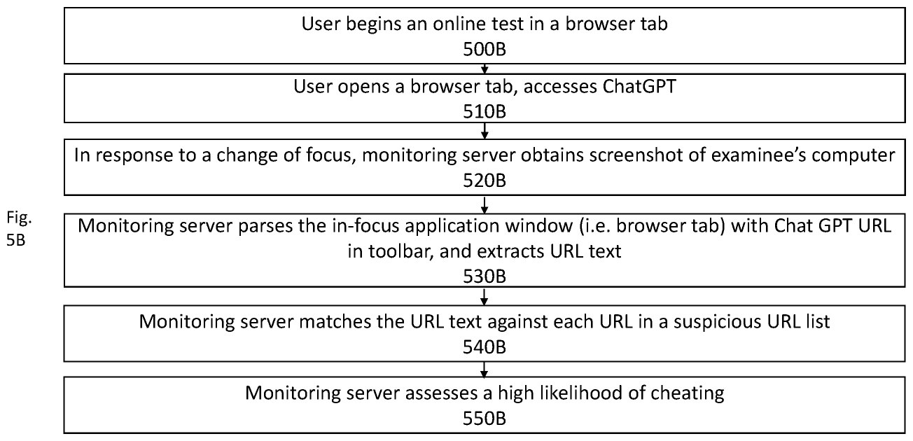

FIG. 5A illustrates an example flow diagram of a user performing an online test, and a monitoring system assessing a likelihood of cheating by the examinee, in accordance with some embodiments of the presently disclosed subject matter.

An examinee utilizing a user computer 190 begins (500B) an online test by entering a URL of an examination server 115 in a browser tab of a web browser 195.

After a certain amount of time, the examinee opens (510B) a second browser tab, and enters a website URL (e.g. a forum for programming tips).

In response to a change of focus to a new browser tab, monitoring server 110 (e.g. screen capture unit 170) then obtains 520A a userscreen image 200A of examinee's user display 180.

Monitoring server (e.g. screen parsing unit 150) then extracts the in-focus application window 210A from the userscreen image 200B, and parses (530B) the application window text 230B and images.

Monitoring server (e.g. content analysis unit 160) then assesses 540B the relevance of the application window text to a text of an examination question (e.g. received from examination server 115). Monitoring server (e.g. content analysis unit 160) can do this e.g. using methods described above with reference to FIG. 3.

Monitoring server (e.g. content analysis unit 160) then finds that the application window text has a particular relevance to the examination question (e.g. high, low, moderate), and accordingly assesses (550B) a likelihood of cheating. A testing organization can then take action accordingly.

FIG. 5B illustrates an example flow diagram of a user performing an online test, and a monitoring system assessing a likelihood of cheating by the examinee, in accordance with some embodiments of the presently disclosed subject matter.

An examinee utilizing a user computer 190 begins (500B) an online test by entering a URL of an examination server 115 in a browser tab of a web browser 195.

After a certain amount of time, the examinee opens (510B) a second browser tab, and enters a URL associated with an interactive language model such as ChatGPT™.

In response to a change of focus to a new browser tab, monitoring server 110 (e.g. screen capture unit 170) then obtains 520A a userscreen image 200A of examinee's user display 180.

Monitoring server (e.g. screen parsing unit 150) then extracts the in-focus application window 210A from the userscreen image 200B, and parses (530B) the application window text 230B and images—including the URL in the toolbar, and extracts URL text.

Monitoring server (e.g. content analysis unit 160) then attempts to match 540B the URL text to URLs in suspicious URL list 165.

Monitoring server (e.g. content analysis unit 160) then finds that the URL of the in-focus application window matches a URL in suspicious URL list 165, and consequently assesses (550B) a high likelihood of cheating. A testing organization can then take action accordingly. It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A computer system of detecting user cheating in an online test, the system comprising a processing circuitry configured to:
a) obtain capability of performing screen capture of a user computer;
b) perform a screen capture of the user computer, thereby giving rise to at least one userscreen image;
c) perform, at least, at least one of:
i. extracting, using image analysis techniques, one or more text strings from, at least, one or more non-examination application windows of the at least one userscreen image,
obtaining at least part of an examination question text that has been presented in an application window on the user computer, and
for at least one of the one or more extracted text strings, determining a degree of relevance to the examination question text, thereby facilitating assessment of a likelihood of cheating, based on the determined degree of relevance, and
ii. determining, using image analysis techniques, a degree of matching between at least part of the at least one userscreen image, and data associated with a suspicious application, thereby facilitating assessment of a likelihood of cheating, based on the determined degree of matching.

2. The system of claim 1, wherein the processing circuitry is configured to perform determining the degree of matching between an image of a browsed uniform resource locator (URL) comprised in the at least one userscreen image, and a given suspicious URL.

3. The system of claim 1, wherein the processing circuitry is configured to perform determining the degree of matching between an at least partial image of a browsed website comprised in the at least one userscreen image, and a given at least partial image of a suspicious website.

4. The system of claim 1, wherein the processing circuitry is configured to perform determining the degree of matching between an at least partial image of a browsed website comprised in the at least one userscreen image, and one or more given text strings of a suspicious website.

5. The system of claim 1, wherein the determining the degree of relevance comprises:
determining a longest common substring between at least part of at least one of the one or more text strings and the at least part of the examination question text.

6. The system of claim 5, wherein the determining the degree of relevance further comprises:
comparing the longest common substring result to a substring matching threshold,
thereby giving rise to a boolean assessment of suspicion of user cheating.

7. The system of claim 1, wherein the processing circuitry is configured to perform screen capture of the user computer responsive to detecting a focus of the user computer being a non-examination application or subapplication.

8. The system of claim 1, wherein the processing circuitry is further configured to:
d) periodically repeat b)-c) one or more additional times.

9. The system of claim 1, wherein the processing circuitry is further configured to, prior to step c):
identify a current in-focus application window in the at least one userscreen image;
reduce the at least one userscreen image to a reduced at least one userscreen image that comprises the identified current in-focus application window.

10. The system of claim 1, wherein the processing circuitry is configured to perform the extracting by, at least:
i. identifying, utilizing image analysis techniques, in the at least one userscreen image, an application window; and
ii. responsive to determining that the identified application window is a non-examination application window, extracting one or more text strings from the identified application window.

11. The system of claim 10, wherein the extracting one or more text strings from the identified application window is responsive to determining that the identified application window is a non-examination application window.

12. The system of claim 11, wherein the determining that the identified application window is a non-examination application window comprises:
comparing an application window identification string with an examination window title.

13. A processing-circuitry-based method of detecting user cheating in an online test, the method comprising:
a) obtaining capability of performing screen capture of a user computer;
b) performing a screen capture of the user computer, thereby giving rise to at least one userscreen image;
c) performing, at least, at least one of:
i. extracting, using image analysis techniques, one or more text strings from, at least, one or more non-examination application windows of the at least one userscreen image,
obtaining at least part of an examination question text that has been presented in an application window on the user computer, and
for at least one of the one or more extracted text strings, determining a degree of relevance to the examination question text, thereby facilitating assessment of a likelihood of cheating, based on the determined degree of relevance, and
ii. determining, using image analysis techniques, a degree of matching between at least part of the at least one userscreen image, and data associated with a suspicious application, thereby facilitating assessment of a likelihood of cheating, based on the determined degree of matching.

14. A computer program product comprising a computer readable non-transitory storage medium containing program instructions, the program instructions when read by a processing circuitry, causing the processing circuitry to perform a method of detecting user cheating in an online test, the method comprising:
a) obtaining capability of performing screen capture of a user computer;
b) performing a screen capture of the user computer, thereby giving rise to at least one userscreen image;
c) performing, at least, at least one of:
a. extracting, using image analysis techniques, one or more text strings from, at least, one or more non-examination application windows of the at least one userscreen image,
obtaining at least part of an examination question text that has been presented in an application window on the user computer, and
for at least one of the one or more extracted text strings, determining a degree of relevance to the examination question text, thereby facilitating assessment of a likelihood of cheating, based on the determined degree of relevance, and
determining, using image analysis techniques, a degree of matching between at least part of the at least one userscreen image, and data associated with a suspicious application, thereby facilitating assessment of a likelihood of cheating, based on the determined degree of matching.
